(19) United States
(12) Patent Application Publication
(10) Pub. No.: US 2025/0067679 A1
(43) Pub. Date: Feb. 27, 2025

(54) SYSTEMS AND METHODS FOR TESTING HEAT TRANSFER FLUIDS

(71) Applicant: VGP IPCO LLC, Lexington, KY (US)

(72) Inventors: Ying Yang, Lexington, KY (US); Dale Reid, Lexington, KY (US); Jennifer Jenkins, Lexington, KY (US); Samuel Elliott, Lexington, KY (US); Virginia Whittington-Byrd, Winchester, KY (US); David E. Turcotte, Lexington, KY (US)

(21) Appl. No.: 18/943,437

(22) Filed: Nov. 11, 2024

Related U.S. Application Data
(63) Continuation-in-part of application No. 17/457,137, filed on Dec. 1, 2021.
(60) Provisional application No. 63/597,637, filed on Nov. 9, 2023.

(51) Int. Cl. G01N 21/88; G01N 25/48; G01N 27/18

(52) U.S. Cl. CPC G01N 21/8803; G01N 25/4826; G01N 27/18

(57) ABSTRACT

A method for testing a heat transfer fluid based on a charged wire test (CWT) includes applying and measuring discharge current through a test circuit formed when a cathode and an anode are at least partially immersed in the heat transfer fluid in a container and a voltmeter coupled to the cathode and the anode is turned on during the CWT. The method includes measuring temperature of the heat transfer fluid during the CWT, determining a current profile based on the measured discharge current, and determining a temperature profile based on the measured temperature. The method includes determining a pass/fail status and/or a rank status of the heat transfer fluid based on pass/fail criteria based on the current profile and the temperature profile during an entire duration of the CWT.

### CROSS-REFERENCED TO RELATED APPLICATIONS

This application claims priority to U.S. Provisional Patent Application No. 63/597,637filed on Nov. 9, 2023 and is a continuation-in-part application of U.S. patent application Ser. No. 17/457,137 filed on Dec. 1, 2021, each of which is incorporated herein by reference in its entirety.

### RELATED TECHNOLOGY

The present disclosure relates to systems and methods for testing heat transfer fluids.

### BACKGROUND

Preventing fires and thermal runaway events is a paramount concern for electrical applications, and especially for the battery electric vehicle industry. Many of these fires have been known to accelerate by a coolant or heat transfer fluid leak in the battery system. Electric vehicle technology has revolutionized the automotive industry. As with any new technology, it is accompanied by many new complications. The cooling solutions formulated for internal combustion engines (ICE) have had difficulty transferring to electric applications due to additional currents flowing outside of the battery enclosure. There have been many cases of fires propagated through leaks of the cooling fluid, also known as heat transfer fluid (HTF). There is a need to develop new approaches to test and formulate heat transfer fluids.

### SUMMARY

In one embodiment, a method for testing a heat transfer fluid based on a charged wire test (CWT) includes applying and measuring discharge current through a test circuit formed when a cathode and an anode are at least partially immersed in the heat transfer fluid in a container and a voltmeter coupled to the cathode and the anode is turned on during the CWT. The method includes measuring temperature of the heat transfer fluid during the CWT, determining a current profile based on the measured discharge current, and determining a temperature profile based on the measured temperature. The method includes determining a pass/fail status and/or a rank status of the heat transfer fluid based on pass/fail criteria based on the current profile and the temperature profile during an entire duration of the CWT.

In another embodiment, a system for performing a charged wire test (CWT) on a heat transfer fluid includes a cathode and an anode, a voltmeter coupled to the cathode and the anode, a container configured to contain the heat transfer fluid, and a temperature measuring device coupled to the container. The system includes a measuring device capable of measuring discharge current through a test circuit formed when the cathode and the anode are at least partially immersed in the heat transfer fluid contained in the container and the voltmeter is turned on during the CWT and measuring temperature of the heat transfer fluid during the CWT.

### BRIEF DESCRIPTION OF THE DRAWINGS

FIG. 1 shows an example test system for performing a charged wire test (CWT) on heat transfer fluids disclosed herein;

FIG. 2 shows example CWT results of electrical current and temperature profiles using copper electrodes;

FIG. 3 shows example CWT results of electrical current and temperature profiles using aluminum electrodes.

FIGS. 4, 5, 6, 7, and 8 each shows images of copper and aluminum electrodes and an example heat transfer fluid post-CWT.

FIGS. 9 and 10 show electrical current profiles of an example heat transfer fluid that passes the CWT on copper electrodes and aluminum electrodes, respectively.

FIGS. 11 and 12 show electrical current profiles of an example heat transfer fluid that fails the CWT on copper electrodes and aluminum electrodes, respectively.

FIG. 13 shows example post-CWT visual inspection criteria of copper and aluminum electrodes immersed in example heat transfer fluids that pass the CWT.

FIG. 14 shows example post-CWT visual inspection criteria for copper and aluminum electrodes immersed in example heat transfer fluids that fail the CWT.

FIG. 15 shows example post-CWT visual inspection criteria for example heat transfer fluids that pass the CWT.

FIG. 16 shows example post-CWT visual inspection criteria for example heat transfer fluids that fail the CWT.

### DETAILED DESCRIPTION

Most electrical energy generation, transfer and storage systems (e.g., solar cells, wind turbines, generators, battery systems, fuel cell systems, capacitor systems, etc.) need heat transfer fluids (e.g., cooling fluids, coolants) for thermal management purposes. Preventing fires and thermal runaway events is a paramount concern for electrical applications, and especially for the battery electric vehicle industry. The present disclosure takes an in-depth look at the materials that could potentially cause a stray current to pass through the fluid in an unintended path by using a testing method referred to as charged wire test (CWT) in the present disclosure.

The CWT in the present disclosure is configured to combat the potentially detrimental effects of what would happen if HTF leaked on or close to a battery by determining the various additives and buffers that could lead to a thermal runaway. In some aspect, the present disclosure focuses on the impact of the buffers having on the HTF, and the potential formation of salt bridges, which may act as a fire propagation path in a HTF leak event in an electric application.

Furthermore, the CWT in the present disclosure is configured to be used as a screening test to help determine safety aspects of the coolants in contact with electrically energized components. As an example, temperature and current profiles may be recorded for the duration of testing along with visual inspection of post-test wires and heat transfer fluids. In some aspect, the method of CWT in the present disclosure is intended to be used as an initial screening tool. Materials displaying positive results are to be marked for further testing and evaluation.

The CWT in the present disclosure creates an electrolytic cell. The voltage is supplied via an external voltage source. As the voltage passes through the fluid (e.g., the HTF being tested), the electrical energy becomes chemical energy. This additional energy causes a typically nonspontaneous redox reaction to occur. The electrolytic cell creates a system where the anode becomes positively charged, and thus, attracts the negatively charged ions in solution. The cathode becomes negatively charged and attracts the positively charged ions in solution. Altogether, the CWT simulates a setting where a metal surface is exposed to HTF in an electrically charged but controlled environment to observe what changes would occur to the metal and the heat transfer fluid over time.

### Test System

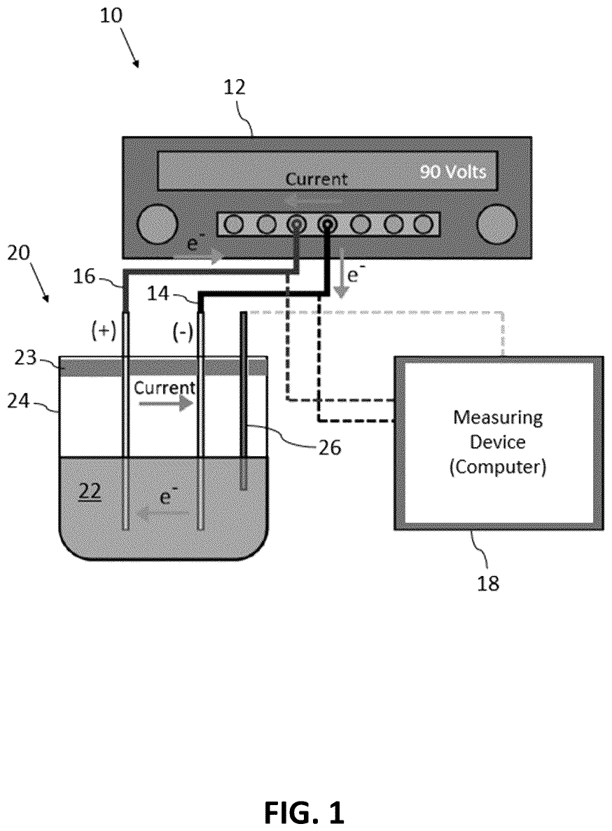

FIG. 1 shows an example test system 10 for performing the CWT disclosed herein. The test system 10 includes a voltmeter 12, a cathode 14 and an anode 16 coupled to the voltmeter 12. The test system 10 includes a measuring device or computer 18 coupled to the cathode 14 and anode 16. The measuring device 18 is capable of measuring a discharge current flow (e.g., an electrical current profile, electrical current v.s. time during the CWT) through a test circuit 20 formed when the cathode 14 and the anode 106 are at least partially immersed in a fluid sample 22 (e.g., the heat transfer fluid) contained in a container 24 and the voltmeter 12 is turned on. The voltmeter 12 may be a 90-volt (V) voltmeter and capable of supplying up to 10 amperes (A) of current per minute or as needed. The cathode 14 and anode 16 may be made of any suitable electrically conductive materials, e.g., aluminum, copper, galvanized steel, etc.). The cathode 14 and the anode 16 may be made of the same material, different materials, or similar materials.

In one example, the container 24 is a 100 milliliter (mL) plastic beaker with about 3 millimeter (mm) epoxy in the bottom with 2 holes about 10 mm apart. The fluid sample 22 is about 40 mL (50/50 mixture by volume). The cathode 14 and the anode 16 are 16-gauge metal wires (e.g., copper, aluminum, galvanized steel, etc.) cut to about 4 inches in length. The container 24 further includes a spacer 23 that spans the width of the container 24 with the two holes drilled about 10 mm apart in the center. Depending on the dimensions of the container 24, the volume of the fluid sample 22 is adjusted such that the cathode 14 and the anode 16 are submersed in the fluid sample 22 in about 1 inch (2.54 centimeter)±10% to obtain CWT results with a high producibility.

The test system 10 further includes a temperature measuring device 26 configured to measure the temperature of the fluid sample 22. The temperature measuring device 26 may be a thermocouple, a resistive temperature measuring device, an infrared sensor, a bimetallic device, a thermometer, a change-of-state sensor, a silicon diode, etc. The measuring device or computer 18 is coupled to the temperature measuring device 26 that is capable of measuring a temperature profile (e.g., temperature v.s. time) of the fluid sample 22 during the CWT.

The measuring device or computer 18 may include any suitable processer (e.g., microprocessor, MOSFET, IGBT, etc.) and memory. The measuring device or computer 18 may include any suitable user interface and/or display to allow a user to program and/or provide inputs to control operations of the test system 10. The measuring device or computer 18 may store instructions to perform CWT tests and/or determine a pass/fail status based on test results.

### Test Procedure and Methodology

In some aspect, a method of performing the CWT using the test system 10 may include following steps. Step 1 includes preparing the fluid sample 22 to be tested as a 50/50 mixture by volume of water and fluid. Step 2 includes placing one wire (e.g., the cathode 14, the anode 16) in each respective hole in the epoxy and thread the wires (e.g., the cathode 14 and the anode 16) through the spacer 23. Step 3 includes securing the spacer 23 to the container 24 (e.g., the beaker) using a tape or any suitable method. Step 4 includes placing the temperature measuring device 26 (e.g., a thermocouple) within about 10 mm of the wires (e.g., the cathode 14 and the anode 16) without touching the wires and securing the temperature measuring device with a piece of tape or any suitable method. Step 5 includes filling about 40 mL of the prepared fluid (e.g., the fluid sample 22) into the container 24 (e.g., the plastic beaker). Step 6 includes attaching one alligator clip or test lead from the voltmeter 12 to each wire (e.g., the cathode 14 and the anode 16). Step 7 includes using the voltmeter 12 to apply a steady 90-Volts voltage for a suitable time duration (e.g., about 30 minutes) and recording the temperature of the fluid sample 22 and the current (in amps) at a suitable time interval (e.g., every 0.25 seconds) throughout the duration of the test.

In some aspect, the CWT is performed for about 30 minutes with data points taken every 0.25 seconds. The data recorded includes time, temperature (° C.) of the fluid sample 22, and current (Amps) flow through the test circuit 20. The CWT exhibits a high reproducibility independent of the fluid samples 22, e.g., the depths of the fluid samples 22 in the container 24 are consistent, about 1 inch (2.54 cm)±10%. To perform the CWT, a 100 mL plastic beaker is used with an epoxy layer about 3 mm thick at the bottom of the container. Two small holes, about 1.3 mm in diameter, are drilled into the epoxy, 1 cm apart to keep the wires (e.g., the cathode 14 and the anode 16) in place during testing. The wires (e.g., the cathode 14 and the anode 16) tested in the present disclosure are 16-gauge pure copper and pure aluminum. Copper is used due to its high electrically conductive properties while aluminum represents what a typical cooling loop is made of in most electric vehicle applications. The wires (e.g., the cathode 14 and the anode 16) are cut to approximately 10 cm in length with no additional preparation prior to the test. For each test, two new wires (e.g., the cathode 14 and the anode 16) are used and held in place by the spacer 23 with two holes about 1 cm apart at the top of the beaker.

A temperature measuring device 16, e.g., a thermocouple, is also placed inside the beaker to record the temperature of the fluid sample 22 during the test. The fluid sample 22 is formulated to match what would typically be in a cooling loop, which is prepared by a 50/50 dilution by volume with distilled water, and the solution is mixed until homogenous. Approximately 40 mL (or about 1 inch±10% in depth) of the fluid sample 22 is poured into the beaker with the wires (e.g., the cathode 14 and the anode 16). Once the alligator clips are attached to the respective wires, the CWT immediately initiates.

After about 30 minutes, images/pictures of the fluid sample 22 are captured post-test, and analysis is performed on the fluid sample 22. In some cases, the fluid sample 22 is filtered to 0.45 micrometers (μm) due to solid deposits after the CWT since the solid deposits can clog the instruments, e.g., High Performance Liquid Chromatography (HPLC), Inductively Coupled Plasma-Optical Emission Spectroscopy (ICP-OES), and ion Chromatography (IC), etc. Fluid analysis included organic acid and metal ion testing are performed while the filtered solids are dried and examined on Scanning Electron Microscopy with Energy-Dispersive X-ray Spectroscopy (SEM/EDS) to determine atomic composition. The wires (e.g., the cathode 14 and anode 16) are allowed to dry overnight before images/pictures are taken to reduce glare caused by any remaining fluid and to avoid damaging SEM/EDS due to exposure to water, and then the deposits on the wires (and sometimes the wires themselves) are examined using SEM/EDS.

### Fluid Samples

Example compositions of fluid samples 22 tested according to the CWT disclosed herein are summarized in Table 1 with the concentration shown in mole fractions. The molar fraction of the inorganic, ionic buffers traditionally used in glycol-based coolants, e.g., lithium hydroxide (LiOH), sodium hydroxide (NaOH), and potassium hydroxide (KOH), are kept as similar as possible for an easier direct comparison on the CWT. A non-ionic, organic buffer, triethanolamine (TEA), is used to highlight the difference between traditional alkali buffers and less traditional non-ionic buffers. TEA is also used at a higher mole percent to further showcase the differences between the buffers. To assist in simulating an HTF, an organic acid is used as the counterpart of the buffering agents.

TABLE 1
Mole Fractions and pH's of the Fluid Samples Tested

| | | | | | Final pH |
|---|---|---|---|---|---|
| | | | | | (50/50 |
| | Ethylene | Organic | | | Solution/ |
| Buffer | Glycol | Acid | Water | Buffer | Water) |
| Lithium | 98.22% | 0.31% | 0.74% | 0.74% | 11.31 |
| Monohydrate | | | | | |
| (LiOH) | | | | | |
| Sodium Hydroxide | 97.22% | 0.30% | 1.70% | 0.77% | 11.42 |
| 50% (NaOH) | | | | | |
| Potassium | 96.19% | 0.30% | 2.78% | 0.73% | 11.51 |
| Hydroxide 45% | | | | | |
| (KOH) | | | | | |
| Triethanolamine | 98.48% | 0.31% | 0.00% | 1.21% | 7.32 |
| 98% (TEA) | | | | | |
| None (Control) | 99.69% | 0.31% | 0.00% | 0.00% | 3.62 |

### Test Results

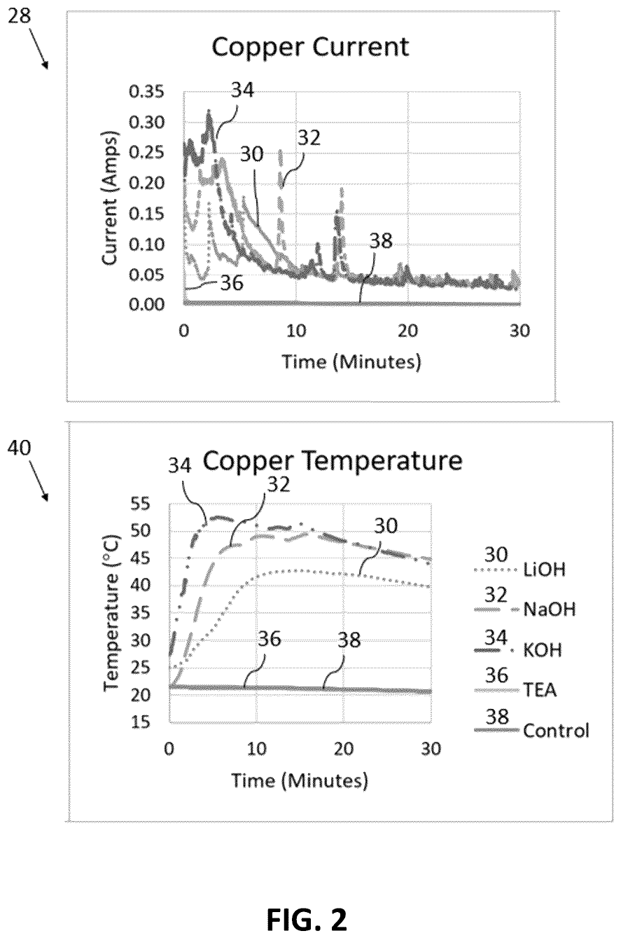

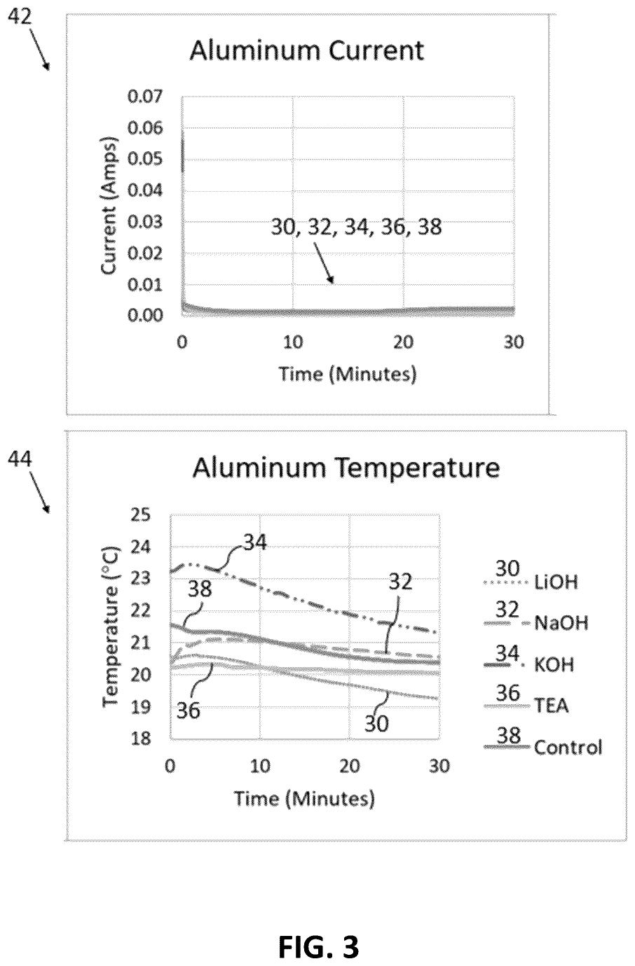

The CWT is performed first with the various buffers in Table 1 as well as a control solution, and the results are shown in FIGS. 2-3. In FIG. 2, the results are obtained based on the cathode 14 and the anode 16 made of copper. A plot 28 shows the measured discharge current flow (Amps) as a function of time (minutes) for a fluid sample 30 with a LiOH butter, a fluid sample 32 with a NaOH, a fluid sample 34 with a KOH buffer, a fluid sample 36 with a TEA buffer, and a fluid sample 38 without a buffer (e.g., a control sample). A plot 40 shows the measured temperature (° C.) as a function of time (minutes) for the fluid samples 30, 32, 34, 36, and 38.

In FIG. 3, the results are obtained based on the cathode 14 and the anode 16 made of aluminum. A plot 42 shows the measured discharge current flow (Amps) as a function of time (minutes) for a fluid sample 30 with a LiOH butter, a fluid sample 32 with a NaOH, a fluid sample 34 with a KOH buffer, a fluid sample 36 with a TEA buffer, and a fluid sample 38 without a buffer (e.g., a control sample). A plot 44 shows the measured temperature (° C.) as a function of time (minutes) for the fluid samples 30, 32, 34, 36, and 38.

The 30-minute CWT reveals that the fluid sample 34 with a KOH buffer has the greatest initial peak in current as well as in temperature with the cathode 14 and anode 16 made of copper. The fluid sample 32 with a NaOH buffer has the second highest initial peak followed by the fluid sample 30 with a LiOH buffer. The fluid sample 36 with a TEA buffer and the fluid sample 38 (e.g., the control sample) without a buffer show the lowest overall current that is closely sustained near 0 Amps on the copper wires, and the temperatures of the fluid samples 36 and 38 both gradually decrease over time.

For the CWT tests on aluminum wires, the results are very similar for all fluid samples 30, 32, 34, 36, and 38 with the current staying close to 0 Amps for the duration of the test. There are slight increases in temperatures on all fluid samples 30, 32, 34, 36, and 38, but the temperature never goes above 24° C. during the test unlike on the copper CWT runs. In fact, the temperatures of all the fluid samples 30, 32, 34, 36, and 38 decrease over time after the initial 5 minutes. In contrast, when copper is used as the cathode and anode material, as shown in the plot 40, the temperatures of the fluid samples 30, 32, and 34 significantly exceed 24° C.

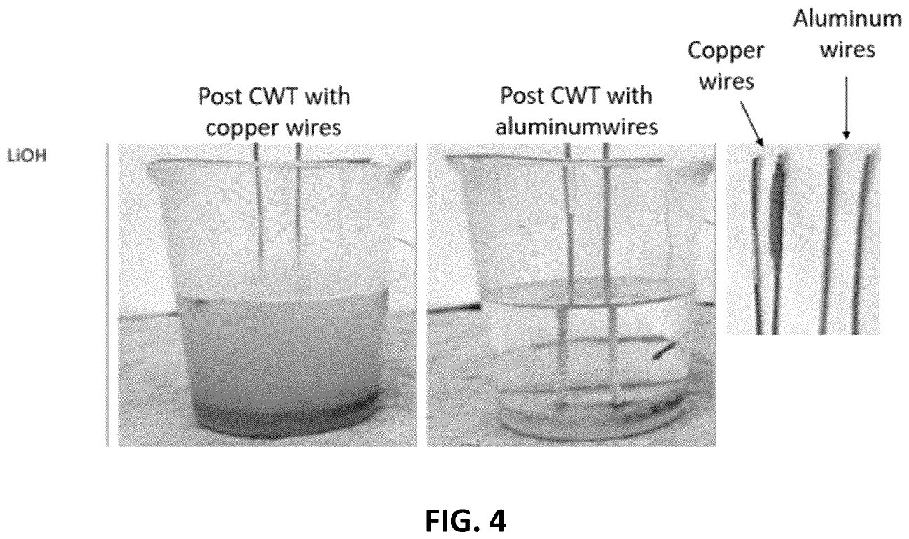

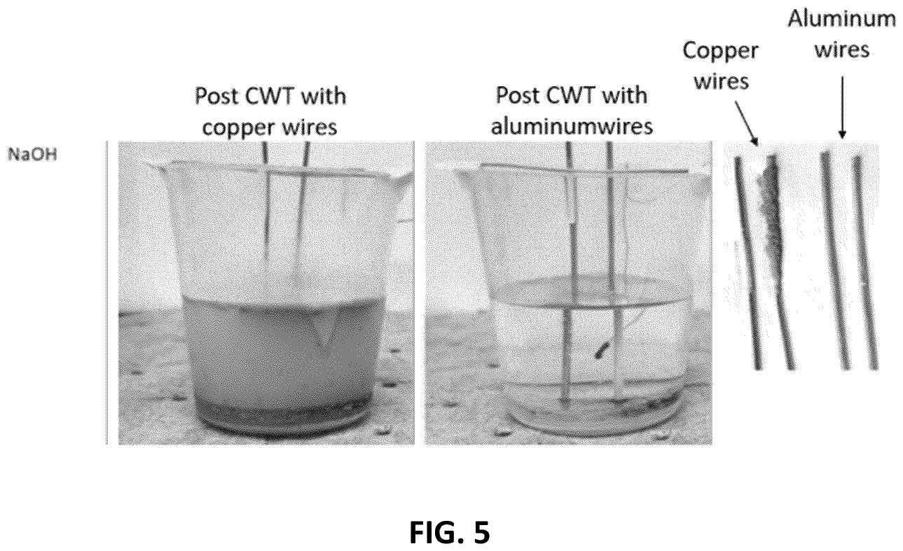

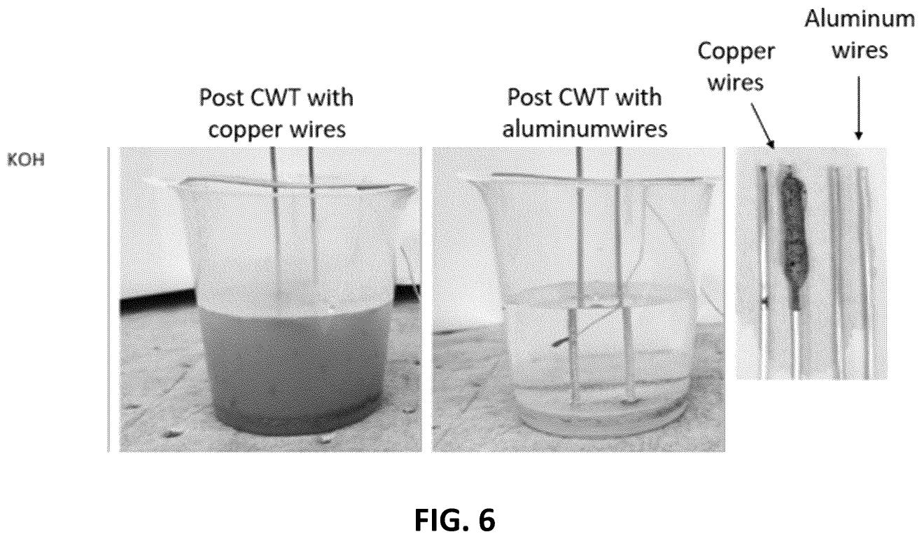

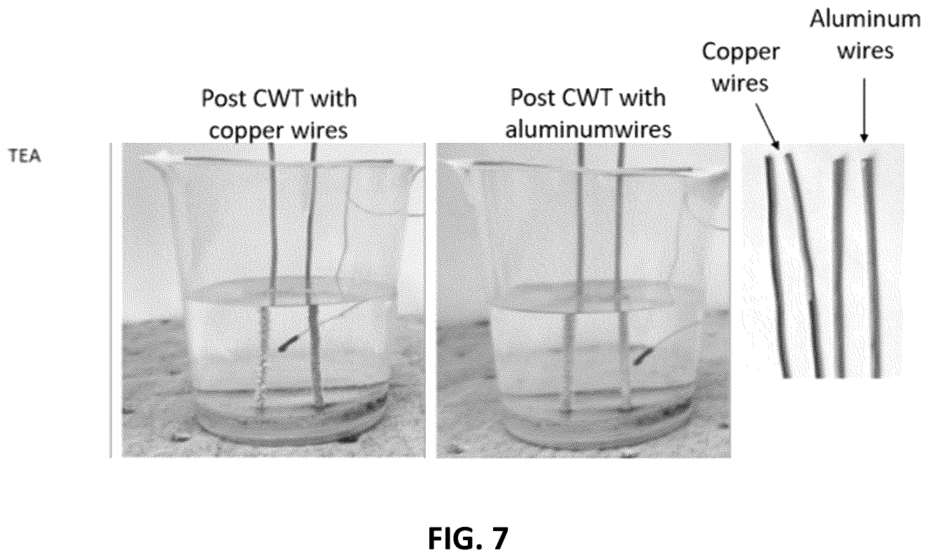

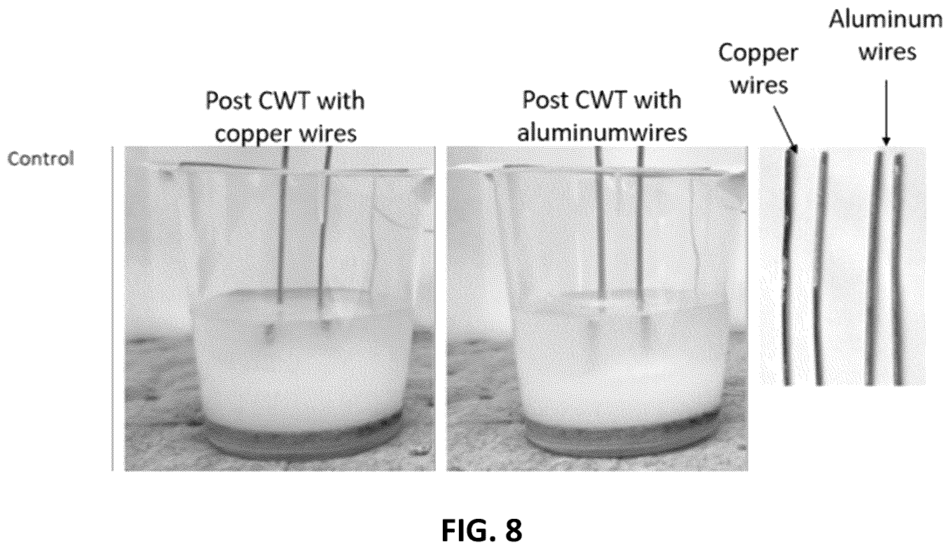

FIGS. 4-8 show images/pictures of the fluid samples 30, 32, 34, 36, and 38 post-test. All fluids are clear post CWT with the aluminum wires while the fluids with copper wires show various colors (e.g., significant color changes/variations). Shown in FIG. 4, the fluid sample 30 with a LiOH buffer and copper wires, exhibits a light-yellow orange color with some blue precipitates on the copper wires. Shown in FIG. 5, the fluid sample 32 with a NaOH buffer and copper wires, exhibits an orange color with more blue precipitates than the fluid sample 30 (LiOH buffer). Shown in FIG. 6, the fluid sample 34 with a KOH buffer and copper wires, exhibits an orange-brown color with the most significant amount of blue precipitates out of the strong base buffers. Shown in FIG. 7, the fluid sample 36 with a TEA buffer and copper wires, exhibits a clear fluid post-test. Shown in FIG. 8, the fluid sample 38 without a buffer and with copper wires, exhibits a white-cloudy color. With reference to the fluid sample 38, the organic acid used has a much lower solubility limit in a 50/50 by volume water and ethylene glycol mixture without a buffer. The white-cloudy color may be a result of the organic acid reaching a saturation limit without any buffer in solution (e.g., the organic acid saturates out of the solution).

Also shown in FIGS. 4-8 are copper and aluminum wires post CWT, with the cathode wire on the left side and the anode wire on the right side. All of the aluminum wires post CWT remain clean and unblemished.

With reference to the copper wires post CWT, the fluid samples 30, 32, and 34 with the LiOH, NaOH, and KOH buffers, produce blue deposits on the copper wires. The blue deposit layer is about 2 mm thick on the copper cathode (e.g., extending about 2 mm away from the surface of the copper cathodic wire). In contrast, the copper anodic wire remains predominantly clean (e.g., only an insignificant amount of precipitates from the solution). The fluid sample 36 with a TEA buffer exhibits a layer of tight adhering blue deposit around the copper cathode, and the copper anode remains unblemished. The fluid sample 38 without a buffer is the only fluid sample that exhibits darkening of the copper anode. The fluid sample 38 exhibits a thin and adhering blue deposit layer on the copper cathode and exhibits an even thinner blue deposit layer on the copper anode. The blue deposit layer on the anode is almost transparent in some spots.

Table 2 shows a summary of metal ion and organic acid fluid analysis of pre-and post CWT fluid samples 22 with wires/electrodes made of copper and aluminum. Prior to running the fluid analysis for metal ions and organic acid, the fluid samples that are not clear have to be filtered to avoid deposits in the instruments. For example, the post CWT fluid samples 30, 32, and 34 with LiOH, NaOH, and KOH buffers and copper wires are filtered prior to performing the metal ion and organic acid fluid analysis. The post CWT fluid sample 38 without a buffer is not filtered prior to performing the analysis because the cloud constituents are easily settled to the bottom of the container. SEM/EDS analysis is performed on all filtered deposits.

TABLE 2
Metal Ion and Organic Acid Fluid Analysis on Pre- and Post-
CWT Fluid Samples with Copper and Aluminum Electrodes

| | | | Copper | Aluminum | Organic Acid |
|---|---|---|---|---|---|
| | Description | pH | (ppm) | (ppm) | (wt. %) |
| LiOH | Pre CWT | 11.31 | 0 | 0.5655 | 0.5408 |
| | Post Cu | 11.33 | 11.442 | 0 | 0.5107 |
| | CWT | | | | |
| | Post Al | 11.27 | 6.6635 | 0.91 | 0.5415 |
| | CWT | | | | |
| NaOH | Pre CWT | 11.42 | 0 | 0 | 0.5045 |
| | Post Cu | 11.43 | 16.5685 | 0 | 0.4569 |
| | CWT | | | | |
| | Post Al | 11.32 | 0 | 0 | 0.5092 |
| | CWT | | | | |
| KOH | Pre CWT | 11.51 | 0 | 0 | 0.4998 |
| | Post Cu | 11.44 | 8.2555 | 0 | 0.4536 |
| | CWT | | | | |
| | Post Al | 11.5 | 0 | 1.115 | 0.4976 |
| | CWT | | | | |
| TEA | Pre CWT | 7.32 | 0 | 0.667 | 0.5023 |
| | Post Cu | 7.36 | 0.911 | 0 | 0.4964 |
| | CWT | | | | |
| | Post Al | 7.36 | 0.145 | 0 | 0.4988 |
| | CWT | | | | |
| Control | Pre CWT | 3.62 | 0.3135 | 0 | 0.0528 |
| | Post Cu | 3.98 | 6.4525 | 0 | 0.0639 |
| | CWT | | | | |
| | Post Al | 3.74 | 0.216 | 0.519 | 0.0602 |
| | CWT | | | | |

As shown in Table 2, the blue precipitates in the fluid samples reveal similar compositions with high weight percents of copper and high atomic percents of oxygen. The brown deposits in the fluid samples also contain various levels of copper and oxygen. The deposits on the copper and aluminum wires (as shown in FIGS. 4-8) are analyzed using SEM/EDS. The compositions found on the cathodes are like the blue precipitates found in the fluid samples and include additional weight percents of carbon. In the fluid sample 34 with the KOH buffer, the post-CWT copper is found to contain a small amount of potassium in all scans. The other cations are searched on their respective wires, but the instrument is not able to produce any reliable information on lithium or sodium due to the small size of these atoms in comparison to potassium. The anode wire in the fluid sample 36 with the TEA buffer is analyzed as well, and very high levels of copper are found in comparison to its respective cathode wire.

The metal ion and organic acid fluid analysis reveal that all fluid samples have similar levels of the organic acid except for the control sample (the fluid sample 38 without a buffer), which has fallout due to the low pH and fluid composition. The fluid samples 30, 32, and 34 with copper wires and LiOH, NaOH, and KOH buffers show various amounts of copper ions in the solutions post CWT. That trend is not reflected in the amount of aluminum ions in the solutions post CWT when aluminum electrodes are used.

### Discussion

The differences are significant between the inorganic bases, LiOH, NaOH, and KOH (e.g., the fluid samples 30, 32, and 34) and the organic base, TEA (e.g., the fluid sample 36). The overall response of the TEA solution on the CWT results in an extremely mild system is similar to the control sample (e.g., the fluid sample 38 without a buffer). Unlike the control sample (e.g., the fluid sample 38 without a buffer) that becomes cloudy due to fallout, the fluid sample 36 with a TEA buffer remains a pristine and clear solution with both metals (e.g., copper and aluminum). The fluid samples 36 (with a TEA buffer) and 38 (without a buffer) display significantly lower levels of current when compared to the fluid samples 30, 32, and 34 with ionic buffers. The current quickly drops below 0.05 amps within a minute for both fluid samples 36 and 38 with both copper and aluminum electrodes. The temperature profiles for both the fluid samples 36 and 38 show a very slight increase around 1° C. before decreasing the remainder of the test. In contrast, the fluid samples 30, 32, and 34 with the three alkaline buffers sustain currents about 0.05 amps for longer than 10 minutes. The temperature profiles are also higher (compared to that of fluid samples 36 and 38), especially with copper electrodes.

Pure water without any salts in solution is considered an electrical insulator, which explains the rapid decrease in current and remains below 0.05 amps throughout the duration of the CWT on fluids samples 36 and 38 (with a TEA buffer and without a buffer). The low current and decreasing temperature profile may be indicative of a fluid with more insulative properties, which may significantly diminish the likelihood of stray current passing through the system from the batteries in an electric vehicle application.

While comparing the overall difference between a strong base and a weak base on the CWT, the various types of strong bases are individually evaluated. The prevailing trend with the cations increases going down the periodic table. Potassium, as the largest cation tested, produces the largest initial increases in temperature and current on the copper CWT; over time, the temperature slowly decreases to match the NaOH solution. However, the current for the KOH case remains consistently high and slowly equalizes toward the values of other cationic solutions (NaOH and LiOH) approaching the end of test duration of 30 minutes, but it never attains the same low sustained current as that seen in the TEA and Control solutions. Potassium even produces a moderate peak on the temperature for the aluminum CWT, which is quite significant considering aluminum is considered more electrically inert than copper and many other metals. The KOH copper solution post-test is the darkest and produces the most significant deposit on the copper wire out of the cations. The darkening of the fluid may be indicative of copper ions in solution, but it may also represent higher levels of oxidation as more water is ionized with the extra energy passing through the solution.

The LiOH and NaOh solutions followed similar trends as KOH with LiOH producing the smallest amount of current and temperature increase for both copper and aluminum wires when compared amongst the cations tested. NaOH is ranked between the LiOH and KOH solutions. This trend may indicate that as the size of the atom increases and the distance of the electrons from the nucleus of the atom also increases, the more likely the solution is to conduct electricity. Therefore, as the electron affinity decreases, the better of a conductor for electricity it can become and a greater response (i.e., temperature and current) occurs on the CWT.

Without being bound by theory, the CWT results from the present disclosure may assist in the removal of strong bases from HTF to assist in preventing the passing of electricity around a battery or electrical application in case of a leak of the fluid. In particular, the inorganic bases in solution create a salt bridge when exposed to high levels of voltage. The TEA solution (e.g., the fluid sample 36) does not contain any strong cations and creates a small, tight deposit around the cathode, similar to the deposit found in the control solution (e.g., the fluid sample 38). The strong bases with similar amounts of cations in solution, create thick deposits that extend outward from the copper cathode. Due to the atomic size of the sodium and lithium, these atoms are not picked up in the SEM/EDS scans, but potassium does register on the SEM/EDS scan on the copper cathode for the potassium solution, which gives merit to the idea of a salt bridge forming from cathode to anode.

Without being bound by theory, an inorganic buffer system and an organic buffer system are different in many aspects when electrically charged in a controlled setting on the CWT. The CWT results in the present disclosure indicate that using an organic buffer may be significantly better in electric applications especially in the electric vehicle industry. An organic buffer in solution creates a less conductive environment where the current is unable to pass as freely through when compared to more conductive counterparts, such as in ionic buffers like LiOH, NaOH, and KOH. A KOH solution creates a salt bridge between the cathode and anode in solution with a copper CWT environment. For coolants containing these ionic bases in solution, the benefits need to be weighed against the conducting effects it has for electrical applications. For the electrical industry, choosing an appropriate fluid to mitigate fire propagation and thermal runaway events.

### Test Evaluation

Based on the CWT results obtained according to the predetermined test conditions (e.g., 90V DC for 30 minutes), heat transfer fluids may be evaluated in terms of a set of predetermined criteria, for example, based on the temperature profile, current profile, degree of deposit formation, and color variation profile of the heat transfer fluid subjected to the CWT.

In one example, the set of predetermined criteria may include a temperature threshold and a current threshold based on the temperature and current profiles of the CWT results. For a heat transfer fluid to receive a “pass” status, the temperature of the heat transfer fluid (e.g., measured by the temperature measuring device 26) must maintain a temperature equal to or below 40° C. throughout the entire duration of the CWT. If the temperature rises above 40° C., the heat transfer fluid is considered a “failure.” For a heat transfer fluid to receive a “pass” status, a current through copper electrodes 14 and 16 (e.g., measured by the measuring device 18) must be below 0.05 Amps by 5 minutes after initiation of the test and stays below 0.05 Amps through the rest of test duration. This criterion becomes 0.005 Amps if aluminum electrodes are used instead of copper.

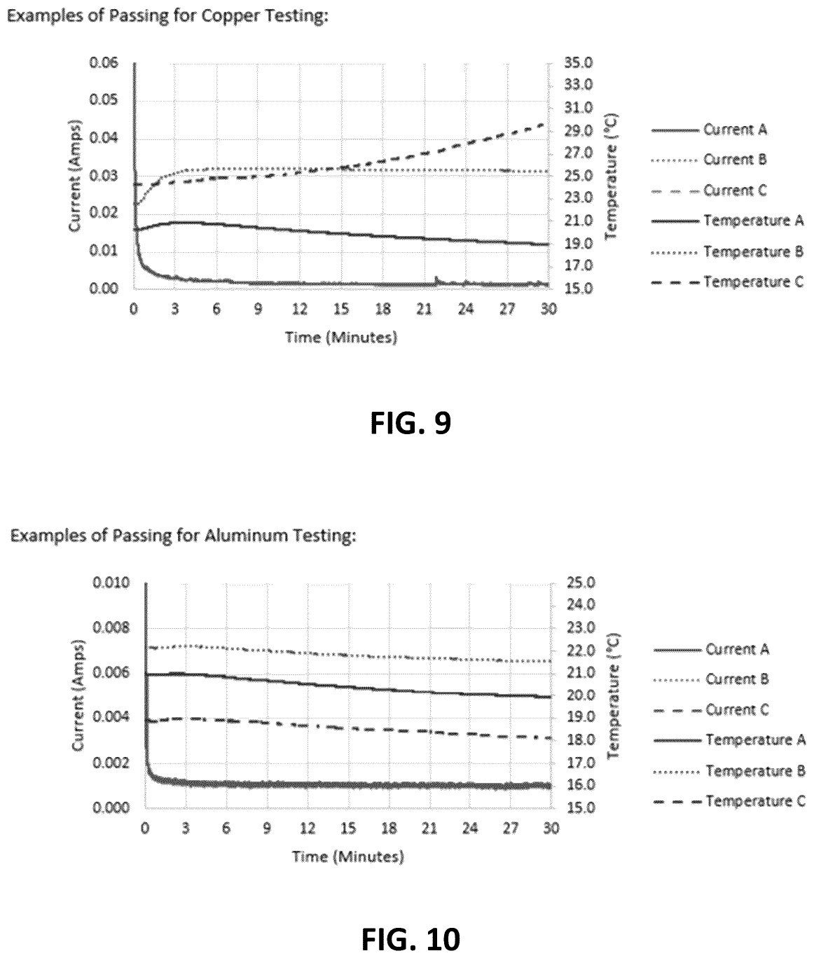

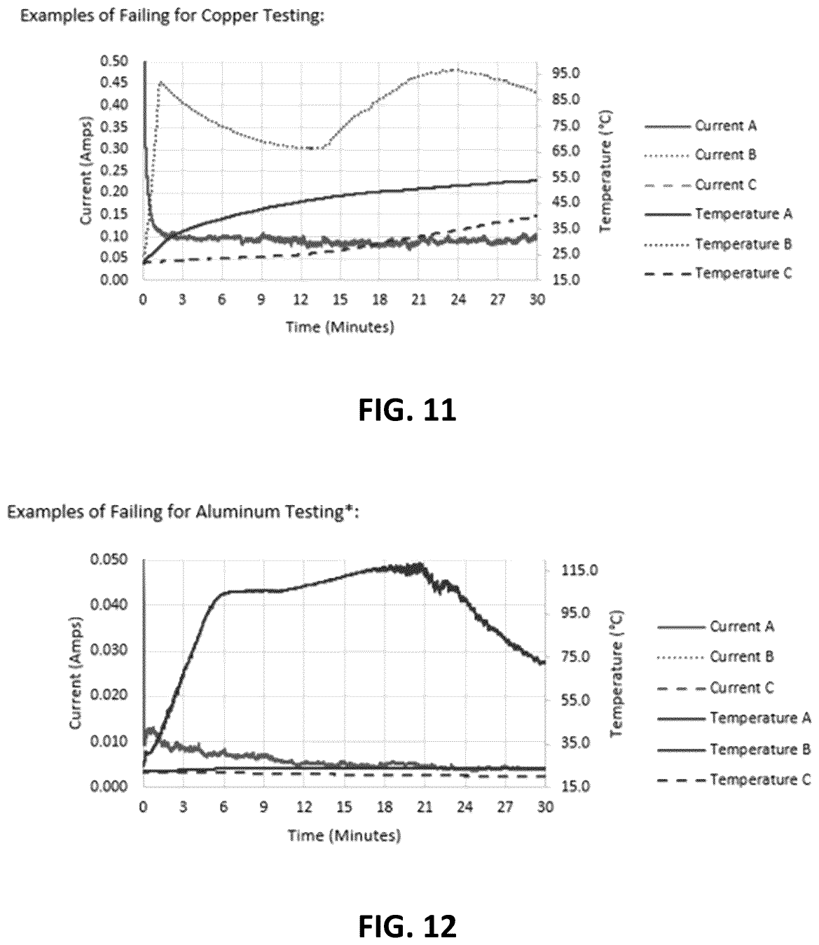

Examples of heat transfer fluids that pass the CWT on copper electrodes and aluminum electrodes are shown in FIGS. 9 and 10, respectively. In contrast, examples of heat transfer fluids that fail the CWT on copper electrodes and aluminum electrodes are shown in FIGS. 11 and 12, respectively. With reference to FIG. 12, it should be noted that although Samples B and C pass the temperature criterion, they fail the current criterion; therefore, Samples B and C fail the CWT.

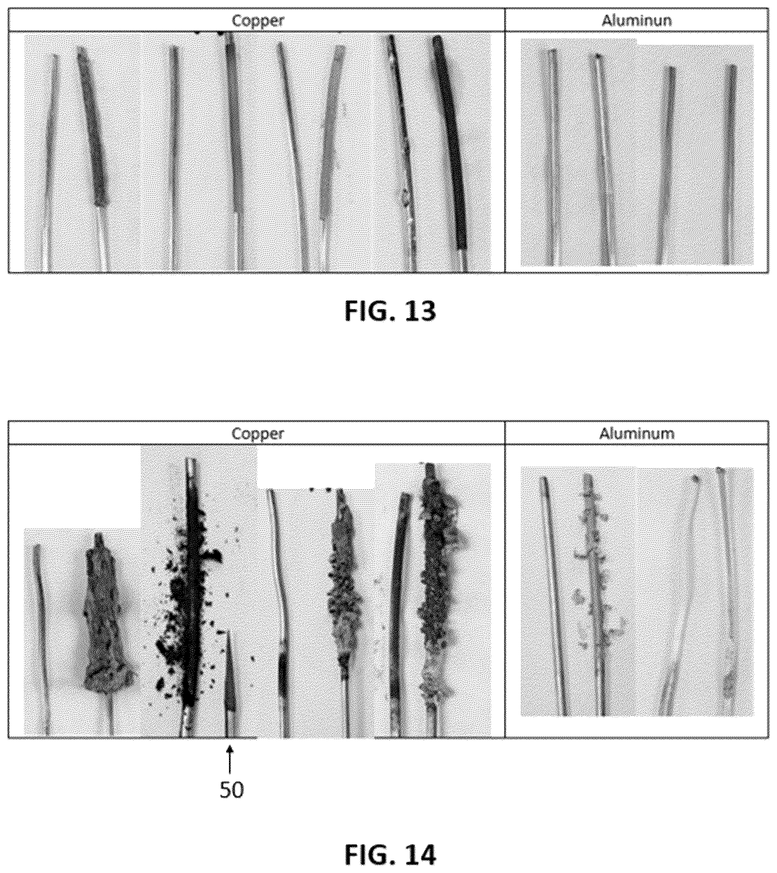

In another example, the set of predetermined criteria may include changes in appearances of the electrodes and the fluid sample post-test. The visual criteria for passing the CWT may include (1) the amounts of deposits on the electrodes is insignificant or below a threshold amount; and (2) the change of the fluid sample (e.g., color change, discoloration, deposit formation, etc.) is insignificant. Examples of visual inspections of the copper and aluminum electrodes that indicate heat transfer fluids passing the CWT are shown in FIG. 13. The deposits on the electrodes are insignificant or the amounts of deposits on the electrodes are less than a pre-determined amount. Examples of visual inspections of the copper and aluminum electrodes that indicate heat transfer fluids failing the CWT are shown in FIG. 14. In some cases, the electrodes even appear to be dissolved (indicated by an arrow 50).

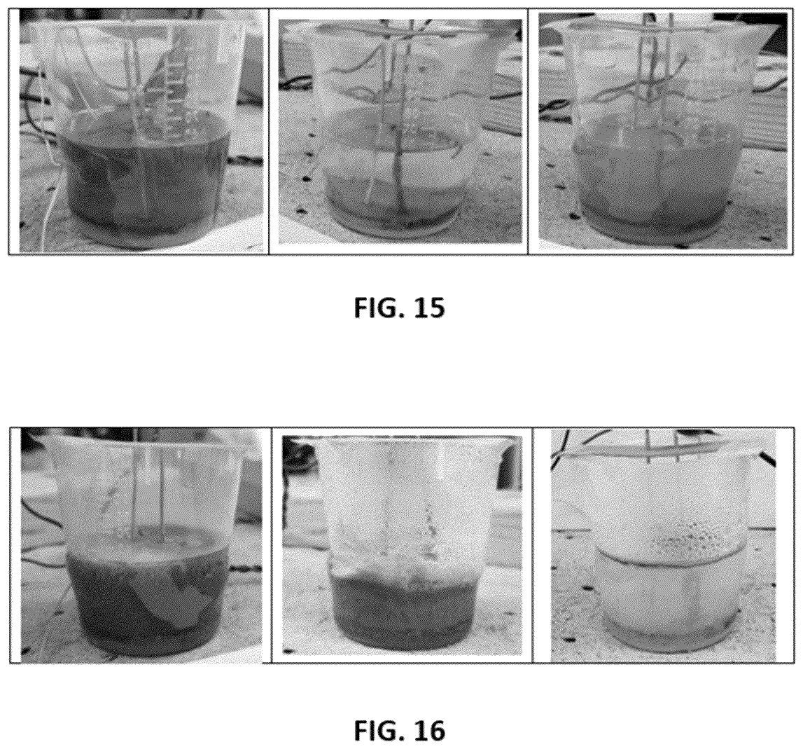

Other examples of visual inspections of the heat transfer fluids passing the CWT are shown in FIG. 15. There is no significant color change in the heat transfer fluids post-CWT and the fluids remain relatively clear or not cloudy deposit formation in the fluid is insignificant. Examples of visual inspections of the heat transfer fluids failing the CWT are shown in FIG. 16. The fluids appear cloudy with significant deposit formation in the fluids. The fluids also show severe evaporation (e.g., about 20%, about 30%, about 40%, about 50%, about 60%, about 70%, about 80%, or about 90% by volume is evaporated), dramatic discoloration, or both.

As general visual inspection criteria, the heat transfer fluid passes the CWT if there were not significant deposits, with visual characteristics including one or more of: (1) the deposit is tightly adhered to the surface of the wire (e.g., a tight adhering layer on the wire, and the color of the deposit does not matter); (2) the wire can be entirely clean, having a semi-transparent deposit, or completely covered; (3) the deposit can appear to be porous as long as it stays tightly bound to the surface with very few flakes coming off when dried; and (4) the aluminum wire typically return clean or with a slight deposit, which can be considered a pass status. As general visual inspection criteria, the heat transfer fluid fails if there were significant deposits or appeared to be dissolved, with visual characteristics including one or more of: (1) the deposit has appeared to be more than double the diameter or characteristic width of the wire; (2) the deposit has a significant amount of flakes that come off the wire when dried (the deposit is not adhered tightly to the surface of the wire); (3) the wire has decreased in diameter or characteristic width or has decreased in volume by a significant amount or extent (or has entirely dissolved in some cases); and (4) the aluminum wire has any kind of deposit greater than a semi-transparent coating or thicker coating. These visual criteria may be used to determine a pass/fail and may also be used to evaluate and rank the heat transfer fluids. The significant amount or extent of the dissolution may be about 20%, about 30%, about 40%, about 50%, about 60%, about 70%, about 80%, about 90%, or about 100% of the original value. For example, if the cathode is completely dissolved during the CWT, the extent of dissolution is 100%.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

The term “substantially” or “about” encompasses a range that is largely (anywhere a range within or a discrete number within a range of ninety-five percent and one-hundred and five percent), but not necessarily wholly, that which is specified. It encompasses all but an insignificant amount.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The recitations of numerical ranges by endpoints include all numbers subsumed within that range (e.g., 0.1 to 5 includes 0.01, 0.05, 1, 1.5, 2, 2.75, 3, 3.80, 4, 5, etc.).

The term “about,” when referring to a value or to an amount of mass, weight, time, volume, concentration, or percentage is meant to encompass variations of ±1.5% from the specified amount. The terms “comprising” and “including” are intended to be equivalent and open-ended. The phrase “consisting essentially of” means that the composition or method may include additional ingredients and/or steps, but only if the additional ingredients and/or steps do not materially alter the basic and novel characteristics of the claimed composition or method. The phrase “selected from the group consisting of” is meant to include mixtures of the listed group.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

What is claimed is:

1. A method for testing a heat transfer fluid based on a charged wire test (CWT), comprising:
applying and measuring discharge current through a test circuit formed when a cathode and an anode are at least partially immersed in the heat transfer fluid in a container and a voltmeter coupled to the cathode and the anode is turned on during the CWT;
measuring temperature of the heat transfer fluid during the CWT;
determining a current profile based on the measured discharge current;
determining a temperature profile based on the measured temperature; and
determining a pass/fail status and/or a rank status of the heat transfer fluid based on pass/fail criteria based on the current profile and the temperature profile during an entire duration of the CWT.

2. The method of claim 1, wherein the pass/fail criteria comprise determining a pass status if the current profile is below about 0.05 amps by about 5 minutes after initiation of the CWT and stays below about 0.05 Amps through rest of the entire duration of the CWT.

3. The method of claim 1, wherein the pass/fail criteria comprise determining a pass status if the temperature profile is equal to or below about 40° C. throughout the entire duration of the CWT.

4. The method of claim 1, wherein the pass/fail criteria further comprise visual criteria of the cathode, the anode, and the heat transfer fluid post the CWT.

5. The method of claim 4, further comprising drying the cathode and the anode and determining an appearance of the dried cathode and anode.

6. The method of claim 4, wherein the pass/fail criteria comprise determining a pass status if an amount of deposits on the cathode and/or on the anode is insignificant.

7. The method of claim 4, wherein the pass/fail criteria comprise determining a pass status if deposits on the cathode or the anode forms a tight adhering layer.

8. The method of claim 4, wherein the pass/fail criteria comprise determining a pass status if a characteristic width of the cathode or the anode with deposits is less than twice of an original characteristic width of the cathode or the anode prior to the CWT.

9. The method of claim 4, wherein the pass/fail criteria comprise determining a fail status if the cathode or the anode dissolves by an significant extent during the CWT.

10. The method of claim 4, wherein the pass/fail criteria comprise determining a fail status if a significant amount of flakes come off the cathode or the anode post CWT and after the cathode and the anode are dried.

11. The method of claim 4, wherein the pass/fail criteria comprise determining a pass status if color change of the heat transfer fluid is insignificant.

12. The method of claim 4, wherein the pass/fail criteria comprise determining a pass status if evaporation of the heat transfer fluid is insignificant.

13. A system for performing a charged wire test (CWT) on a heat transfer fluid, comprising:
a cathode and an anode;
a voltmeter coupled to the cathode and the anode;
a container configured to contain the heat transfer fluid;
a temperature measuring device coupled to the container; and
a measuring device capable of:
measuring discharge current through a test circuit formed when the cathode and the anode are at least partially immersed in the heat transfer fluid contained in the container and the voltmeter is turned on during the CWT; and
measuring temperature of the heat transfer fluid during the CWT.

14. The system of claim 13, wherein the cathode and the anode are made of copper.

15. The system of claim 13, wherein the cathode and anode are made of aluminum.

16. The system of claim 13, further comprising a spacer having at least two holes for securing the cathode and the anode in the container at a distance apart from one another and such that the cathode and the anodes are at least partially immersed in the heat transfer fluid.

17. The system of claim 16, wherein the spacer further comprises a hole for securing the temperature measuring device in the container such that the temperature measuring device is at least partially immersed in the heat transfer fluid.

18. The system of claim 13, wherein the measuring device is configured to display or output an electrical current profile based on the measured discharge current during the CWT.

19. The system of claim 13, wherein the measuring device is configured to display or output a temperature profile based on the measured temperature during the CWT.

20. The system of claim 13, wherein the measuring device is configured to determine a pass/fail status of the heat transfer fluid based on the measured discharge current and the measured temperature during the CWT.
